(19) United States
(12) Patent Application Publication
(10) Pub. No.: US 2003/0187785 A1
(43) Pub. Date: Oct. 2, 2003

(54) Telecom credit system

(76) Inventor: Robert Bernstein, Northfield, IL (US)

Correspondence Address: Welsh & Katz, Ltd., Jon P. Christensen, 22nd Floor, 120 South Riverside Plaza, Chicago, IL, 60606, US

(21) Appl. No.: 10/114,624

(22) Filed: Apr. 2, 2002

(51) Int. Cl. G06F 17/60

(52) U.S. Cl. 705/39

(57) ABSTRACT

An apparatus and method are provided for satisfying a debt owed by an account holder to a vendor. The method includes the steps of providing a payment terminal to the account holder that can be remotely controlled by a telecom credit provider, receiving a request for payment to the vendor, such request being provided through the payment terminal to the telecom credit provider and providing a promise from the telecom credit provider to pay the vendor, such promise be provided through the payment terminal directly to the vendor.

### FIELD OF THE INVENTION

The field of the invention relates to the payment of debt from remote locations.

### BACKGROUND OF THE INVENTION

The purchase of goods or services for cash or on credit is a relatively well understood concept. Typically, the process involves the use of cash, check or card (e.g. credit card, ATM card, etc.).

Usually, the purchaser selects a purchased item and presents cash, check or his credit or debit card to a vendor. The vendor takes information from the card. While a sales credit form is being prepared for signature, the card reader (or clerk) of the vendor will often call an issuing bank of the credit card for an authorization number. The authorization number may be printed or written onto the form before signature.

In general, the use of a credit or smart card is a promise of payment made by the bank issuing the credit card to the vendor. Following acceptance of the credit purchase, the vendor then takes the signed credit form and deposits the form with his own bank.

The vendor's bank, in turn, presents the signed credit form to the issuing bank and, upon receiving payment, deposits the money in the vendor's account. While existing methods of cashless purchases are effective, they also provide innumerable opportunities for error or fraud. For example, if the vendor should misplace or lose the signed credit form, then he may be unable to collect on the purchase. Alternatively, if a credit card number or authorization number is obliterated, then the vendor, again, may be unable to collect on the purchase.

Further, existing credit card processes usually involve the telephone infrastructure of the vendor. Where a vendor's telephone is busy or out of order, the vendor must make the decision of turning away business or taking credit cards that may be stolen or otherwise over the credit limit. Because of the importance of credit purchases, a need exists for a better method of executing cashless transactions.

### SUMMARY

An apparatus and method are provided for satisfying a debt owed by an account holder to a vendor. The method includes the steps of providing a payment terminal to the account holder that can be remotely controlled by a telecom credit provider, receiving a request for payment to the vendor, such request being provided through the payment terminal to the telecom credit provider and providing a promise from the telecom credit provider to pay the vendor, such promise be provided through the payment terminal directly to the vendor.

### BRIEF DESCRIPTION OF THE DRAWINGS

FIG. 1 is a block diagram of a telecom credit payment system in accordance with an illustrated embodiment of the invention; and

FIG. 2 is a block diagram of a payment terminal and vendor electronic device of the system of FIG. 1.

### DETAILED DESCRIPTION OF AN ILLUSTRATED EMBODIMENT

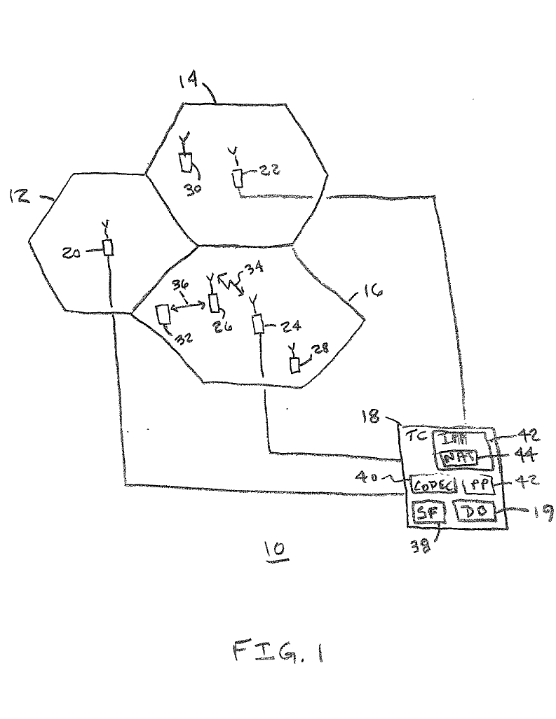

FIG. 1 is a block diagram of a telecom debt payment system (telecom system) 10, shown generally under an illustrated embodiment of the invention. Under the illustrated embodiment, the telecom system 10 is a comprehensive debt payment system operated under control of a telecom credit provider that can be used under proper circumstances to guarantee the purchases of account holders worldwide.

The operation of the telecom system 10 differs from the prior use of credit and smart cards in that no bank is involved. Whereas prior credit and smart card issuers used the telephone simply as a medium to exchange credit card account and authorization numbers, the telecom system 10 uses secure links and verification procedures that provide a high degree of reliability against fraud. Further, purchases made by an account holder may be placed into an account maintained by the telecom system 10 for the account holder and billed monthly to the account holder along with other telecom (e.g., cellular telephone) charges.

Alternatively, the account holder may periodically (or even intermittently) deposit additional funds with the telecom system 10. The presence of deposited funds may allow the account holder to use the telecom system 10 in a manner similar to an automatic teller machine (ATM) and may, in fact, withdraw money from actual ATM machines based upon his account balance with the telecom system 10.

Account holders may subscribe to services through the telecom system 10 on any of a number of different levels. At a first level, an account holder may subscribe to services on a cash basis by depositing a predetermined minimum amount of money with a representative of the telecom system 10 and entering into a license agreement allowing the account holder the use and possession of a payment terminal.

Alternatively, the account holder may make application to the telecom system 10 for a credit account. After confirming the creditworthiness of the applicant, the telecom system 10 may open a credit account and, again enter into a license agreement allowing the account holder the use and possession of a payment terminal.

The payment terminal may be owned by the account holder or the telecom company. The only requirement is that the telecom company be able to remotely control the payment terminal.

In general, the payment terminal has a user (account holder) interface, a vendor interface and a telecom interface. The vendor interface allows vendors to make offers (propose purchases). The user interface allows the account holder to enter identifiers (e.g., personal identifier numbers (PINs), accept or reject vendor offers, check account status with the telecom system 10, etc.).

The vendor interface also allows the vendor to propose related transactions. The account holder may either reject or accept some or none of the proposed transactions.

In contrast, the telecom interface functions to allow the telecom system 10 to control the payment terminal by establishing separate, secure logical links with both the vendor and with the user interface. Encryption techniques may be used to ensure the security of the logical links.

The use of separate logical links allows the telecom system 10 to independently verify and confirm the legitimacy of each party to the transaction. By being able to confirm the legitimacy of each party to the transaction, the telecom system 10 is, in effect, able to independently confirm the legitimacy of the transaction itself. By being able to independently confirm the legitimacy of the transaction, the telecom system 10 is able to contractually commit itself to payment of the debt incurred by the account holder. The telecom system 10 may memorialize the commitment by transmission of indicia of the commitment (e.g., a credit authorization number) through the secure link to the vendor.

Periodically, the telecom system 10 may settle accounts with the vendor. Where both the vendor and account holder subscribe to the telecom system 10, settlement may means simply transferring funds among accounts maintained by the telecom system 10. Where the vendor is not a subscriber, settlement may be accomplished by forwarding negotiable tender (e.g., a check) to the vendor. Alternatively, the telecom system 10 may settle accounts with a bank of the vendor or telecom of the vendor based upon a proper identification of the commitment (e.g., based upon the indicia of commitment).

Under the illustrated embodiments, the telecom system 10 may offer service locally, nationally and internationally through any of a number of service areas 12, 14, 16, as shown in FIG. 1. Within each area 12, 14, 16, service may be offered to account holders using a payment terminal (PT) 26, 28, 30 through one or more local transceivers (e.g., the local transceivers also sometimes referred to herein as “base stations”) 20, 22, 24 based within respective service areas 12, 14, 16.

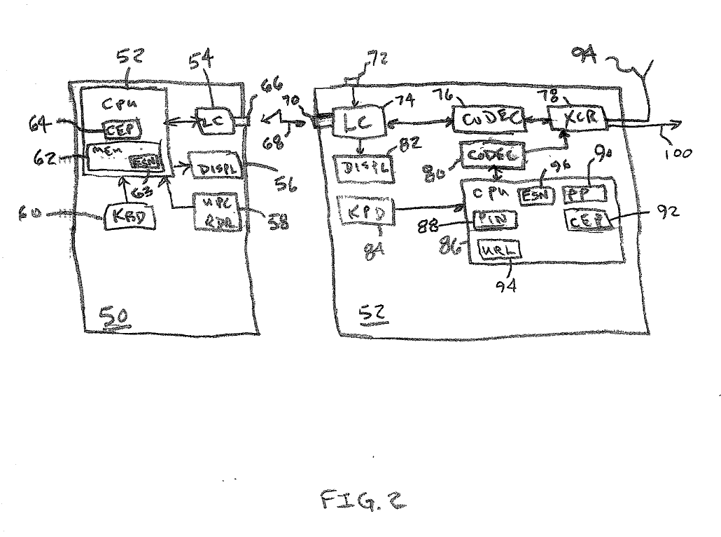

Located within the service areas 12, 14, 16 may be any of a number of vendors (e.g., vendor 32 shown in service area 16). Vendors 32 in the context of another person may sell goods using a cash register attended by a clerk or through an automatic vending machine. In either case, the vendor 32 may be provided with an electronic device for accepting payment (electronic cash box) 50 (FIG. 2) able to interact with and exchange information with the PTs 26, 28, 30 of FIG. 1.

The electronic device 50 may receive information about purchases to be made by the account holder under any of a number of different formats. For example, the electronic device 50 may receive descriptive information and prices through a keyboard 60 used by a clerk of the vendor or by the account holder himself in the case of a vending machine purchase. Alternatively, a UPC bar code reader 58 may scan purchased items and transfer any detected codes to a CPU 52. The CPU 52 may then retrieve product information and prices from a memory 62.

FIG. 2 shows the electronic device 50 of the vendor and also a block diagram 52 of a payment terminal 26, 28, 30. As shown, the payment terminals 26, 28, 30 may be structured to communicate with the electronic device 50 over communications link 68 (e.g., infrared (ir), radio frequency (rf), wireline, etc.). In the case of an ir link 68, the account holder may place the payment terminal 26, 28, 30 into a cradle adjacent the electronic device 50. Placement of the payment terminal 26, 28, 30 into the cradle may bring a light emitting diode/photodector combination 70 (together hereinafter referred to as the “LED/PD 70”) of the payment terminal 26, 28, 30 into alignment with an LED/PD 66 of the vendor's electronic device 50.

Within the PTs 26, 28, 30, the LED/PD 70 may form the vendor interface. A link controller (LC) 74 may be provided to receive information from and provide information to the LED/PD 70. The LC 74 is also shown coupled to a display 82 that may be used to display information received through the interface 68.

The LC 74 may be hard coded to only respond to commands from the telecom processor 18. In a quiescent state, the LC 74 may be programmed to simply establish a link through the LED/PD 70 and display any received information on the display 82. However, upon receiving the proper command, the LC 74 may also function to set up a secure communication link with the telecom processor 18, as discussed in more detail below.

A keypad 84 may be provided on the user interface. The user interface may be used to allow the account controller to verify his identity. The user interface also allows the user to accept or reject purchase offers from vendors, also as discussed in more detail below.

A cellular transceiver 78, first CODEC 76 and second CODEC 80 may provide the telecom interface. While the telecom interface may be activated and deactivated through the user interface, the telecom interface is also hard coded for specific modes of operation. For example, the CPU 86 of the user interface and LC 74 of the vendor interface are each assigned separate code plugs. In addition to being hard coded into the vendor and user interface, the identity of those code plugs may be stored in a subscriber file located within the telecom processor 18.

Once a communication link is established between the PT 26, 28, 30 and the telecom processor 18, the telecom processor 18 may retrieve the code plugs associated with both the vendor and using interface. Using the code plugs, the telecom processor 18 may, as necessary, establish separate secure links with the user interface and/or vendor interface.

To use the payment terminal 26, 28, 30, an account holder may first activate an ON button on the keypad 84 and enter a personal identification number (PIN). A PIN processing application 90 within the CPU 86 may compare the PIN entered through the keypad 84 with a PIN 88 in memory. If the PINs match, the CPU 86 activates the payment terminal 26, 28, 30.

Once the payment terminal 26, 28, 30 has been activated, the CPU 86 may activate a transceiver 78 and search for a channel used by a local base station 24. Upon locating a channel used by the base station 24, the CPU 86 may compose an access request. The access request may be transferred through the CODEC 80 (operating in a clear mode) to the transmitter 78. The access request may include an identifier of the payment terminal 26, 28, 30 (e.g., a MIN number, IMSI number, etc.).

The base station 24 may respond with an acknowledgement including a randomly generated call identifier. The call identifier may be used by the base station 24 and payment terminal 26, 28, 30 as a pseudo-address to identify subsequent transmissions between the base station 24 and payment terminal 26, 28, 30.

Once received, the base station 24 may transfer the access request to the telecom processor 18 for authentication. Using well known techniques, the telecom processor 18 may transfer an identity challenge back to the PT 26, 28, 30.

Within the PT 26, 28, 30, the challenge may be transferred to a challenge encryption processing application (CEP) 92 inside the user interface. Within the CEP 92, the challenge may be encrypted using an electronic serial number (ESN) 96 of the PT 26, 28, 30. Once encrypted, the encrypted challenge may be returned to the telecom processor 18.

Within the telecom processor 18, the original challenge and encrypted challenge may be forwarded to a database 19 (e.g., a Radius database by Funk) where the encrypted challenge may be decoded using its own knowledge of the encryption process used by the CEP 92 within the PT 26, 28, 30. From the decryption process, the database 19 may recover the ESN 96 of the payment terminal 26, 28, 30.

With the ESN 96 of the PT 26, 28, 30, the telecom processor 18 may access a set of subscriber files 38 of the account holder. From the subscriber files, the telecom processor 18 may recover a set of code plugs of the interfaces as well as account holder information.

With the code plugs of the user and vendor interface and the pseudo-address of the PT 26, 28, 30 assigned during call set up, the telecom processor 18 may begin setting up separate secure links between a CODEC 40 of the telecom processor 18 and the CODECs 76, 80 of the PT 26, 28, 30. Exchanges between the telecom processor 18 and the vendor interface through a secure vendor link may be encoded (i.e., encrypted) under a first format (i.e., using a first public key) and exchanges with the user interface through a secure user link may be encoded under a second format (i.e., using a second public key). The formats to be used may be based upon a subscriber level that may be stored within both the PT and telecom processor 18.

To use the payment terminal 26, 28, 30, the user may place the payment terminal 26, 28, 30 in the cradle adjacent the electronic device 50 and activate a link activation button 72. Activation of the link activation button 72 activates the LC 74, that, in turn, begins setting up a communication link across the wireless interface 68.

A corresponding link control 54 within the vendor's device 50 receives the set-up messages and transfers the messages to the CPU 52. If the account holder has made a purchase, the CPU 52 encodes a summary of the purchase, including a description of any goods included within the purchase and the total price, and transfers the summary back across the link 68.

The link controller 74 within the payment terminal 26, 28, 30 receives the summary and transfers the summary to a display 82. The account holder may review the summary and approve or reject the purchase offer shown within the display 82.

The account holder may accept the offer by activating an ACCEPT key on the keypad 84. In response, the CPU 86 may transfer a purchase request to the telecom processor 18.

In response to the purchase request, the telecom processor 18 may retrieve the code plug of the LC 74 and transfer an identity challenge back to the CPU 52 of the vendor's electronic device 50 through the vendor interface and secure link. A challenge encryption processing (CEP) application 64 may encode the challenge using an ESN 63 of the electronic device 50. The encrypted challenge may be transferred back to the telecom processor 18 through the secure vendor link passing through the PT 26, 28, 30.

While the CEP 64 of the electronic device 50 is processing the challenge, the LC 74 of the PT 26, 28, 30 may begin transferring the summary over the vendor secure link to the telecom processor 18. Once the summary is received, a payment processor 42 within the telecom processor 18 may begin to evaluate the contents of the purchase summary against a security criteria. For example, one level of the security criteria may be to determine whether the value of the purchase exceeds credit limits provided for the account holder. Another level may check to see whether the PT 26, 28, 30 has been reported stolen. Another level may check to determine when the last payment was made on the holder's account. Still another level may be to check whether the current purchase are consistent with previous purchases.

If one or more security criteria are not met, then the telecom processor 18 may ask for additional information through the user secure link. Additional information may include a mother's maiden name, the date a payment was mailed (if a payment is overdue), etc.

Once the CEP 64 of the vendor has finished processing the challenge, the encoded challenge may be uploaded through the secure vendor link to the telecom processor 18. Using a similar process, the telecom processor 18 may transfer the encoded challenge to the datebase 19 to identify the vendor via retrieval of the ESN 63 of the vendor.

Once the ESN 63 of the vendor has been retrieved, the telecom processor 18 may perform further checks of authenticity. For example, the telecom processor 18 may download an address request or a request for credit information (e.g., an identifier of the vendor's bank, credit sources, etc.). The telecom processor 18 may receive this information and perform whatever further checks are necessary and then proceed to finalize the transaction.

Finalizing the transaction may include transfer of indicia of identity (e.g., name and address of a business office) of the telecom system 10 and a credit authorization number. Alternatively, additional information may be requested (and provided) so as to allow the vendor (and electronic device 50) to evaluate its own credit risk. This situation may exist where the vendor has not previously dealt with this particular telecom system 10. The downloaded information may include credit references. Alternatively, the downloaded information may include a telephone number of identifier of a website where the vendor may verify entry of and acceptance of the purchase.

Under another embodiment, the payment terminal 52 and vendor device 50 may be interconnected through a cable network or the public switch telephone network and an Internet Service Provider (ISP). In this case, a wireline link 100 may connect the payment terminal 52 with the telecom processor 18 through landlines. The communication link 68 and link between the payment terminal 52 and telecom processor 18 may exist through those landlines and Internet as separate logical links.

Control of transactions between the payment terminal 52 and Internet vendor 50 are accomplished by routing all packets between the payment terminal 52 and vendor 50 through an Internet packet processor (IPP) 42 within the telecom processor 18. A network address translation (NAT) module 44 within the IPP 42 may function to route packets between the payment terminal 52 and Internet vendor 50.

The account holder 52 may initiate a contact with an Internet vendor 50 by entering a URL of the Internet vendor 50 through the keyboard 84. The CPU 86 may encapsulate the URL of the Internet vendor 50 within a packet addressed to the telecom processor 18 using the URL 94 of the telecom processor 18 stored within memory.

Within the telecom processor 18, the URL of the Internet vendor 50 is retrieved and used to set up logical links as discussed above. The display 82 may be used to display webpages from the Internet vendor 50. The keyboard 84 may be used by the account holder to make selections and request payment.

Upon receiving a request for payment, the telecom processor 18 uploads a webpage summary of the purchase from the display 82. From the webpage, the telecom processor 18 retrieves a URL of the vendor. Using the URL of the Internet vendor 50, the telecom processor 18 is able to independently verify the transaction. By being able to independently verify the transaction, the telecom processor 18 is able to guarantee payment to the Internet vendor 50 as discussed above.

Using the ISP connection, the payment terminal 52 may be used for any of a number of local or remote purchases. Gas bills may be charged to the telecom account. Likewise, electric bills may be paid remotely.

In another embodiment, the use of PIN numbers may be obviated where the payment device 52 exhibits other indicia of identity. For example, where the payment device 52 accesses the telecom processor 18 from a known port (a home or office telephone of the account holder), then a reduced security level may be justified. In this case, the identity of the port may be determined using existing techniques (e.g., ANI).

Further, the payment device may be used where the account holder has multiple extensions (e.g., the account holder is a stock broker). As above, the identity may be verified using ANI. Charges to individual extensions may be accumulated based upon ANI.

A specific embodiment of a method and apparatus for the payment of debt according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A method of satisfying a debt owed by an account holder of a telecom credit provider to a vendor, such method comprising the steps of:
providing a payment terminal to the account holder that can be remotely controlled by the telecom credit provider;
receiving a request for payment to the vendor, such request being provided through the payment terminal to the telecom credit provider; and
providing a promise from the telecom credit provider to pay the vendor, such promise being provided through the payment terminal directly to the vendor, based upon the payment request received through the payment terminal.

2. The method of satisfying a debt as in claim 1 further comprising setting up a secure vendor link and a secure user link between the payment device and telecom credit provider.

3. The method of satisfying a debt as in claim 1 further comprising sending an identity challenge to the vendor through the secure vendor link.

4. The method of satisfying a debt as in claim 3 further comprising encoding the identity challenge with an electronic serial number of the vendor and sending the encoded identity challenge to the telecom credit provider through the secure vendor link.

5. The method of satisfying a debt as in claim 2 where in the promise of payment further comprises transferring a credit authorization number to the vendor through the payment device and secure vendor link.

6. The method of satisfying a debt as in claim 2 further comprising activating a payment accept button on the payment device by the account holder for transfer through the secure user link.

7. The method of satisfying a debt as in claim 2 further comprising encoding the vendor identifier and payment amount for transmission through the secure vendor link.

8. The method of satisfying a debt as in claim 7 further comprising transmitting the encoded vendor identifier and payment amount to the telecom operator through the secure vendor link.

9. The method of satisfying a debt as in claim 1 further comprising activating the payment terminal upon entry of a personal identification number of the account holder into the payment device.

10. The method of satisfying a debt as in claim 1 further comprising coupling the payment device to a vendor electronic cashbox through a wireless interface.

11. The method of satisfying a debt as in claim 8 further comprising transferring a vendor identifier and a payment amount from the vendor electronic cashbox to the payment device through the wireless interface.

12. The method of satisfying a debt as in claim 8 further comprising prepaying the telecom credit provider.

13. An apparatus for satisfying a debt owed by an account holder of a telecom credit provider to a vendor, such apparatus comprising:
a payment terminal provided by the telecom credit provider for use by the account holder in satisfying debts to vendors;
means for remotely controlling the payment terminal by the telecom credit provider;
means for receiving a request for payment to the vendor, such request being provided through the payment terminal from the account holder or vendor to the telecom credit provider; and
means for providing a promise from the telecom credit provider to pay the vendor, such promise being provided through the payment terminal directly to the vendor, based upon the payment request received from the account holder or vendor.

14. The apparatus for satisfying a debt as in claim 13 further comprising means for setting up a secure vendor link and a secure user link between the payment device and telecom credit provider.

15. The apparatus for satisfying a debt as in claim 14 further comprising sending an identity challenge to the vendor through the secure vendor link.

16. The apparatus for satisfying a debt as in claim 15 further comprising means for encoding the identity challenge with an electronic serial number of the vendor and sending the encoded identity challenge to the telecom credit provider through the secure vendor link.

17. The apparatus for satisfying a debt as in claim 14 wherein the means for promising payment further comprises means for transferring a credit authorization number to the vendor through the payment device and secure vendor link.

18. The apparatus for satisfying a debt as in claim 14 further comprising means for encoding the vendor identifier and payment amount for transmission through the secure vendor link.

19. The apparatus for satisfying a debt as in claim 18 further comprising means for transmitting the encoded vendor identifier and payment amount to the telecom operator through the secure vendor link.

20. The apparatus for satisfying a debt as in claim 13 further comprising means for activating the payment terminal upon entry of a personal identification number of the account holder into the payment device.

21. The apparatus for satisfying a debt as in claim 13 further comprising means for coupling the payment device to a vendor electronic cashbox through a wireless interface.

22. The apparatus for satisfying a debt as in claim 21 further comprising means for transferring a vendor identifier and a payment amount from the vendor electronic cashbox to the payment device through the wireless interface.

23. An apparatus for satisfying a debt owed by an account holder of a telecom credit provider to a vendor, such apparatus comprising:
a payment terminal provided by the telecom credit provider for use by the account holder in satisfying debts to vendors;
a telecom processor adapted to remotely control the payment terminal;
a payment processor adapted to receive a request for payment to the vendor, such request being provided through the payment terminal from the account holder or vendor to the telecom credit provider; and
a secure vendor link providing a promise from the telecom credit provider to pay the vendor, such promise being provided through the payment terminal directly to the vendor, based upon the payment request received from the account holder or vendor.

24. The apparatus for satisfying a debt as in claim 23 further comprising a secure user link disposed between the payment device and telecom credit provider.

25. The apparatus for satisfying a debt as in claim 23 further comprising a database adapted to send an identity challenge to the vendor through the secure vendor link.

26. The apparatus for satisfying a debt as in claim 25 further comprising challenge encoding processor adapted to encode the identity challenge with an electronic serial number of the vendor and sending the encoded identity challenge to the telecom credit provider through the secure vendor link.

27. The apparatus for satisfying a debt as in claim 24 wherein the payment processor further comprises a link controller adapted to transfer a credit authorization number to the vendor through the payment device and secure vendor link.

28. The apparatus for satisfying a debt as in claim 24 further comprising a codec adapted to encode the vendor identifier and payment amount for transmission through the secure vendor link.

29. The apparatus for satisfying a debt as in claim 28 further comprising a wireless transceiver adapted to transmit the encoded vendor identifier and payment amount to the telecom operator through the secure vendor link.

30. The apparatus for satisfying a debt as in claim 23 further comprising a wireless interface adapted to couple the payment device to a vendor electronic cashbox.

31. The apparatus for satisfying a debt as in claim 30 further comprising a link controller adapted to transfer a vendor identifier and a payment amount from the vendor electronic cashbox to the payment device through the wireless interface.
